(19) United States
(12) Patent Application Publication
(10) Pub. No.: US 2008/0198531 A1
(43) Pub. Date: Aug. 21, 2008

(54) CAPACITIVE DEIONIZATION SYSTEM FOR WATER TREATMENT

(75) Inventors: Lih-Ren Shiue, Hsinchu (TW); Mu-Fa Chen, Tulsa, OK (US); Chun-Shen Cheng, Kaohsiung City (TW); Yi-Shuo Chen, Nantou County (TW); Yu-Chun Chang, Hsinchu County (TW); Masami Goto, Tokyo (JP)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: Lih-Ren Shiue, Hsinchu (TW)

(21) Appl. No.: 11/675,608

(22) Filed: Feb. 15, 2007

(51) Int. Cl. H01G 9/00

(52) U.S. Cl. 361/434

(57) ABSTRACT

A capacitive deionization (CDI) system for deionizing water is disclosed. The CDI system comprises at least a flow through capacitor (FTC) module, at least a first supercapacitor, at least a second supercapacitor, at least a third supercapacitor and a controller. The FTC module comprises a plurality electrodes for removing ions from water flowing between the electrodes under an electric field applied between the electrodes. The first supercapacitor is connected between the potential source and the FTC module for amplifying energy provided by the potential source. The second supercapacitor is connected to the FTC module for receiving energy from the FTC module for regenerating the electrodes of the FTC module. The third supercapacitor is adapted for exchanging energy with the FTC module for regenerating the electrodes of the FTC module. The controller is adapted for regulating deionization rate of the water and regeneration of the electrodes of the FTC module.

### BACKGROUND OF THE INVENTION

1. Field of the Invention

The present invention generally relates to water purification. More particularly, the present invention relates to a capacitive deionization system for deionizing water.

2. Background of the Related Art

Water purification may be implemented by a variety of techniques, such as, reverse osmosis (RO), ion exchange or electrodialysis just to name few. With increasing environment protection awareness, an ideal water purification technique should be cost effective and pollution free in addition to reliability of the water purification technique. From pretreatment of water to maintenance of the equipments, all of the aforementioned water purification techniques utilize one or many kinds of chemicals resulting in secondary pollution and increase cost. Capacitive deionization (CDI) technique, which solely depends on electricity for performing water treatment and also for maintaining the equipment, presents an environmentally advantageous approach of being chemical and pollution-free. The operation of CDI includes a series of charging and discharging of the flow-through capacitor (FTC) comprising a positive electrode and a negative electrode. At the charging of the capacitor, a static electrical field is created between the electrodes, which will readily adsorb ions from water flowing between electrodes of the FTC. The adsorbed ions accumulate on the surface of electrodes, and the accumulated ions must be discharged in order to regenerate the surface of the electrode surface to continuously treat water. Power consumption for charging the electrodes to remove ions is low, about ⅓ of that used in RO to yield an equivalent amount of water at comparable level of purity. Furthermore, the capability of discharging the saturated electrodes presents the opportunities of reducing the electric energy and recover useful ions. Therefore, CDI provides a value-added technique for purifying water from ion-tainted waters, for example, industrial wastewater, surface and underground brackish water, as well as seawater. The viability of the CDI technique for commercial use is greatly dependent upon the ion-adsorption capability of the capacitor and regeneration effectiveness thereof.

Compared with RO and ion-exchange, CDI is a relatively new and significantly unknown for capability of reducing TDS of water, and therefore the CDI technique is far less explored by the academies or industries compared to RO, ion exchange and electrodialysis techniques. The configuration of the electrode pair and the capability of CDI go hand-in-hand on merits of implementing the CDI technique as a commercial means for the treatments of various waters and desalination of seawater. The first development of FTC for commercial use included a stack of several hundred pairs of electrodes connected in series, disclosed in U.S. Pat. No. 5,980,718. As disclosed in '718, a low DC voltage is applied to each electrode pair, and the electrical connection is complex and expensive. A much more energy and cost effective FTC is disclosed in U.S. Pat. No. 6,462,935. Though the electrical connection is greatly simplified in '935, the cylindrical FTC suffers cross contamination, particularly, from treating highly concentrated water, for example, seawater. Consequently, the output of the CDI operation is severely impaired due to the significant loss of ion-adsorption capability of FTC.

Since the CDI operation relies on a static electric-field between the electrode pairs of the FTC for removing ions, the minimal number of electrical connection between FTC and a power supply is two, that is, the positive and negative terminals. This is exactly the electrical connection of the FTC in '935, wherein only two electrode plates are concentrically wound into a roll of any desired surface areas with two terminals. Due to the close and tight enclosure of FTC, water is prone to be trapped in the roll causing serious cross contamination during the CDI operation. For rapid and effective regeneration of the FTC electrodes, the surface of the FTC electrodes is rinsed with the cleaning water. The electrical connection of the juxtaposed FTC electrodes with a power supply is designed economically and efficiently, and they are not directly connected to the power supply. The remaining FTC electrodes are electrically connected by the water flowing through the FTC electrodes array. The potential voltage applied between the end electrodes, the water to be treated is charged from the top end electrode so that current starts to flow. As current with water emerge at the second side of the first intervening electrode, the second side of the electrode will carry the same polarity as the top end electrode. Similar polarity alternation synchronized with the flow of current/water though the electrode array will recur continuously until the water emerges out from the bottom end electrode. Each of the electrode pair has two different polarities, and when they are connected in series, the FTC electrodes are bipolar, and when they are connected in parallel, the FTC electrodes are monopolar.

Bipolar electrodes are widely employed in many electrochemical processes for various purposes. For example, bipolar electrodes are used for even electro-deposition of metals as disclosed in U.S. Pat. No. 4,043,891, for electro-synthesis of chemicals as disclosed in U.S. Pat. Nos. 5,322,597; 6,787,009 and 7,018,516, for electrolytic disinfection of water as disclosed in U.S. Pat. Nos. 5,439,577 and 5,744,028, as well as for load leveling via regenerative fuel cells as described in “Pure Appl. Chem., Vol. 73, No. 12, pp. 1819-1837 (2001)”. Not only the bipolar electrodes can be removable than being firmly sandwiched between two end plates as shown in U.S. Pat. No. 6,224,720, but also they can be in any form, such as of balls as taught in U.S. Pat. No. 6,306,270. By using different electrode materials, bipolar electrodes can also applied in the CDI technique. One such application is disclosed in U.S. Pat. No. 6,788,378 wherein the electrodes are disposed in a series-parallel combination. In the perspective of CDI technique, '378 is disadvantageous in using RuO₂.xH₂O as the ion-adsorption material and the edges of electrodes are not sealed. Though RuO₂.xH₂O has a high energy density for making supercapacitor as an energy-storage device, the energy capacity of the expensive material is derived from surface reduction-oxidation reaction that is of no use for the CDI operation wherein only ion-adsorption is needed. Furthermore, the exposed edges of the electrodes may allow water to bypass without being treated, also current to leak around the edges cause ohmic heating and other damages.

Thus, in view of the foregoing problems, the present invention presents a novel system and method for the regeneration of FTC modules so that the CDI technique may be viable to treat water at industrial scale for industrial use.

### SUMMARY OF THE INVENTION

The present invention is directed to a structure of a FTC module. An assembly of prefabricated electrodes may be utilized to construct the FTC module having high electrode-utilization efficiency, and rapid and effective electrode regeneration. Low-cost electrodes may be used to construct the FTC module, and the TFC module may be easily integrated into new or existing equipment used for performing purification of waters.

According to an embodiment of the present invention, for achieving high ion adsorption capacity, materials with large surface areas, for example, activated carbon or carbon nanotube, is selected fabricating the FTC electrodes. The adsorptive material may be mixed with fabric fibers to form carbon cloth, or the adsorptive material can be securely attached to a metallic substrate using a suitable binder or directly grown on the metallic substrate. It is preferred that the electrodes should have a high permeability to water and high conductivity. Water to be deionized is flowed from a top end electrode between the FTC electrodes to the bottom end electrode of the FTC electrodes array such that the water comes in direct contact with all the FTC electrodes.

According to an embodiment of the present invention, only the two end electrodes are electrically connected to the power supply, and the applied voltage is evenly distributed among the entire juxtaposed FTC electrodes. When the FTC electrodes have a high electrical conductivity, say about 0.01 Siemen/cm or higher, a strong electric field is established between every electrode pair. Under such a strong electric field, high ion-removal rates may be achieved.

According to an embodiment of the present invention, the electrodes are embedded in a sealing member seal the edges of the FTC electrodes so that leakage of any untreated water does not cross contaminate the treated waters.

According to an embodiment of the present invention, the sealing member comprises a plurality of radially arranged stripes surrounded by an edge sealer. The sealing member may be fabricated by using, for example an injection molding process, wherein a stripes and the edge sealer are simultaneously formed. The sealing member is comprised of an insulating material and function to prevent electric shorts between the FTC electrodes. Current leaks around the edges not only impair the ion-removal rate, the leaks may also cause ohmic heating and other damages to the integrity of FTC electrodes. The untreated water around the edges of FTC electrodes will have profound effect on the ion-removal rate than the leakage of current, wherein a single drop of untreated water may contaminate four liters of treated water into un-acceptable quality. By embedding the FTC electrodes in the sealing members, the FTC electrodes can be rendered as add-on components to greatly facilitate the construction of FTC modules.

It should be noted that carbonaceous materials, particularly activated carbon, are widely used in the pretreatment unit process as they inherently adsorb ions from waters, in various industrial water treatment plants that include expensive RO membranes and ion exchange resins. However, once the activated carbon becomes saturated, the whole pack load of activated carbon, sometimes in hundreds of tons, is discarded. Therefore usage of the activated carbon in water treatment that can be recovered or regenerated is a serous environmental concern. Even though it is possible to regenerate the activate carbon, it can be implemented at a large expense of energy and water as the contaminants are deeply trapped in the porous structures of carbon.

The present invention provides a method for regenerating FTC electrodes, wherein supercapacitors are used for rapidly regenerating the FTC electrodes. First, the energy of the FTC electrodes is discharged to the supercapacitors, which serve as a reservoir to store the energy discharged by the saturated FTC electrodes. Next, the residual energy of FTC electrodes is exchanged between FTC modules and supercapacitors together with the circulation of rinsing water. During the regeneration process, the polarities of the electrodes of FTC modules are reversed periodically so that the residual energies of FTC modules and supercapacitor can charge and discharge to each other such that the residual energy of FTC modules is consumed by a series of minor electric shorts. Meanwhile, the adsorbed ions are removed from the surface of the FTC electrodes and carried away by the rinsing water. As a result, the FTC modules is regenerated and suitable for reuse treat the waters.

### BRIEF DESCRIPTION OF THE DRAWINGS

The present invention is best understood by reference to the embodiments described in the subsequent sections accompanied with the following drawings.

FIG. 1 is a schematic diagram of a capacitive deionization system comprising a FTC module including a plurality of juxtaposed electrodes according to an embodiment of the present invention.

FIG. 2 is a schematic view of an electrode of the FTC module according to an embodiment of the present invention.

FIG. 3 is a schematic view of a capacitative deionization system comprising two FTC modules connected in series in a housing according to an embodiment of the present invention.

FIG. 4 shows an automated CDI water treatment system including the bipolar FTC.

### DETAILED DESCRIPTION OF THE INVENTION AND BEST MODES

The preferred embodiments of the flow through capacitor (FTC) using including bipolar electrodes according to an embodiment of the present invention are presented as follows.

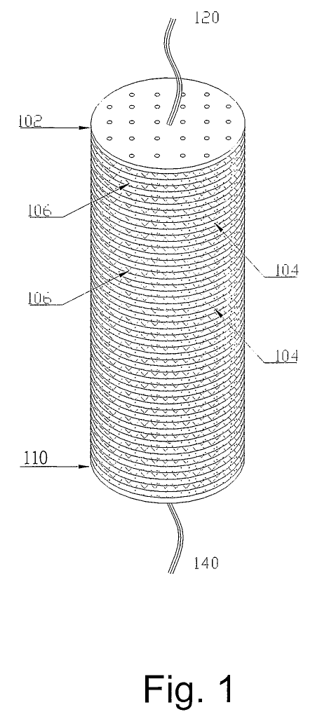

FIG. 1 shows a schematic configuration of a FTC module according to an embodiment of the present invention. The FTC module 100 comprises a plurality of juxtaposed electrodes 104 arranged in an array and a plurality of spacers. Two end plate electrodes 102 and 110 electrically connected to wires 120 and 140, respectively, for connecting to a power supply. The end electrodes 102 and 110 comprise metal substrates, for example, comprised of nickel, stainless steel or titanium. Each substrate comprises a pattern of 1 mm diameter perforated holes to allow water to flow there-through. The shape of the pattern may include mesh, net, screen or web. The substrate may be coated with a layer of activated carbon, or other suitable carbonaceous material or conductive metal oxides, for protecting the substrate and also for adsorbing ions from the waters. The electrodes 104 and the spacers 106 are alternately arranged such that one spacer 106 is sandwiched between two electrodes 104 as shown in FIG. 1 to prevent the shorting of the electrodes 104. The shape of the electrodes 104 may be identical to that of the end electrode plates, or may be made of carbon cloth, a woven mixture of activated carbon and fabrics. Each of the spacers 106 may be comprised of about 0.6-1 mm thick plastic or polymer plate. The spacers 106 may have a pattern of a mesh, net, screen or web.

A DC potential is applied across the end electrodes 102, and 110, and water flow is passed between the electrodes 104, the electrodes 104 will be energized by the water flow under the electric field between the electrodes 104. For example, it is assumed that water enters the FTC module 100 from the positive end electrode 102 and 110 as shown in FIG. 1, when the water arrives at the first side of the first electrode 104, a negative polarity will be induced on the first side thereof. As water emerges at the second side of the first intervening electrode, a positive polarity will be induced on the second thereof. As the water continuously flows down the column of the electrodes 104 of the FTC module 100, every electrode 104 will be energized in a manner described above. Meanwhile, an electric current will flow through the FTC array with the liquid current flowing in and out of every bipolar electrodes 104.

There are at least two advantages on using the FTC module 100 configuration as shown in FIG. 1 for the CDI (capacitive deionization) operation. First, waters to be treated by the CDI technique come in direct contact with every electrodes 104 of the FTC module 100. Since the CDI technique relies on the adsorption of ions on the surface of the charged electrodes to reduce the TDS (total dissolved solid) of water, the water must contact the electrodes for quick and effective treatments. During the CDI process, water will fill the entire FTC array, for example, by gravity feed, leaving no area of the electrodes untouched. Henceforth, the efficiency of electrode utilization of the FTC module 100 is high, which is beneficial to the throughput of CDI treatment. Secondly, the flow paths of the FTC module 100 are straightforward with no dead corners or traps so that the water can easily exit the FTC module 100. Due to quick saturation of the electrodes from adsorbing ions, the electrodes 104 requires frequent regenerations. One technical challenge to the regeneration of the electrodes is cross contamination that is mainly due to the entrapment of contaminants in the FTC module 100, particularly, if the flow paths of the FTC array are long and tortuous. Any pair of oppositely disposed positive side and negative side of any two electrodes of the FTC constitutes a capacitor. As brackish waters flow through the FTC module 100, cations of the treated waters are adsorbed on the positive sides, whereas anions are adsorbed on the negative sides. The foregoing capacitive ion-adsorption is exactly the mechanism that the electrochemical capacitors adapt to store electric energy. During the regeneration of the electrodes 104, the electrodes 104 are desorbed via discharge by connecting the two electric leads 120 and 140 to a load, for example, an empty supercapacitor, which saves the remaining energy of the FTC module 100 for latter use. In the mean time, the desorbed ions must be flushed out of the FTC module 100 by a rinsing water. The open configuration of the FTC module 100 allows the rinsing water with the desorbed ions to drain completely to reduce the possibility of cross contamination.

It should be noted that it is very important to minimize cross contamination, and therefore the present invention proposed using the spacers 106 to reduce the possibility of leakage of untreated water bypassing the electric field between the electrodes 104. A single drop of untreated water may contaminate four liters of purified water to an unacceptable purity level. Moreover, the electric current may also leak along with the evaded water around the edges of the bipolar electrodes 104. Such leakage current, also known as “shunt current”, will cause the ohmic heating at the edges of the bipolar electrodes 104 making the edges the hot spots of the FTC module 100 at the expense of the current efficiency of deionization. The edge effect may also cause the electrolysis of water resulting in the increase of TDS impairing the throughput of the CDI treatments.

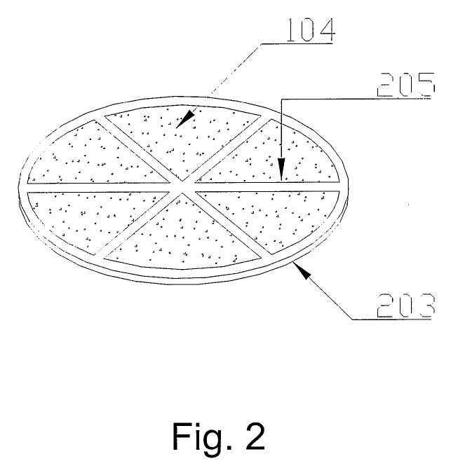

FIG. 2 shows a preferred embodiment of minimizing the bypass water and the shunt current by embedding the electrode 104 in a sealing member including a plurality of radially arranged stripes 205 surrounded by an edge sealer 203. The stripes 205 and the edge sealer 203 may be simultaneously formed in one injection molding process. The stripes 205 and the edge sealer 203 may be comprised of insulating material including EPDM (ethylene propylene diene monomer), epoxy modified silicone, EVA (ethylene vinyl acetate), nylon and Teflon. By embedding the electrode 104 in the sealing member, the electrode 104 can be a self-sustained component that can greatly facilitate the assembly of the FTC module 100 as shown in FIG. 1. The sealing member also provides a fixed gap of, for example, 1 mm between the bipolar electrodes 104, which is crucial in determining the voltage distribution of the FTC module 100. As the electrodes 104 of the FTC module 100 are connected in series, any voltages applied across the end electrodes 102 and 110 will be shared by all cells. It is important that the applied voltage must be evenly distributed, otherwise, the cell with the highest voltage will be the weakest and hottest point of the FTC module 100. A constant electrode gap can contribute to the uniform cell resistivity of the FTC module 100 for uniform voltage distribution. Another factor that may also affect the cell resistivity is the bulk conductivity of the electrodes 104, which is in turn decided by the material of the electrode 104 including the ion-adsorptive medium and the substrate. Contrary to each cell having an operating voltage, there is only one operating current for all cells in the entire FTC module 100. The operating current is a measure of the adsorption rate of ions on the electrodes when a DC voltage is applied to the FTC module 100. High operating current means ions are adsorbed rapidly, and the throughput of the water treatment is high. Nevertheless, the CDI process is operated under a constant voltage, whereas the corresponding current is determined by the applied voltage, ion concentration, electrode area, electrode conductivity and electrode gap. In the foregoing parameters, the electrode conductivity should be optimized through the fabrication of electrodes 104. The preferred electrode conductivity is 0.001 Siemen/cm or higher.

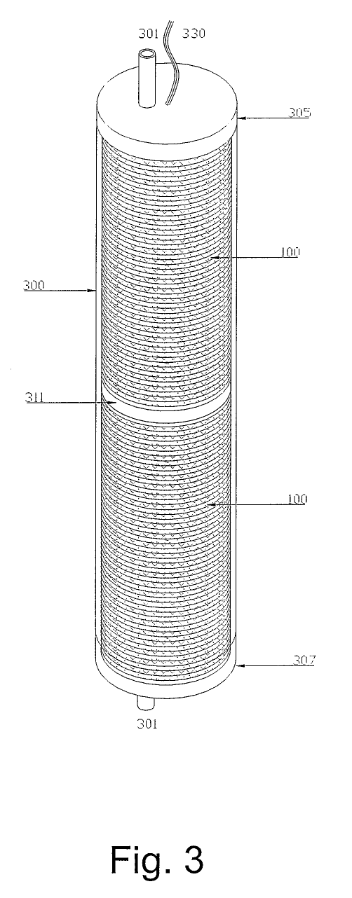

For treating large-scale waters, for example, 10 tonnes per hour, the FTC module 100 must possess a large electrode surface area to meet the desired treatment capacity. The FTC module 100 comprises serially connected bipolar electrodes 104, and an operating voltage is applied to the bipolar electrodes for treating the water flowing between the bipolar electrodes. For example, if the number of bipolar electrodes 104 is 40 including the two end electrodes 102 and 110, and the CDI process is targeted at 1 DC V/cell, an overall operating voltage should be limited to 40 V DC. Moreover, a plurality of FTC modules 100 may be integrated for constructing a larger system for treating a larger scale of water. FIG. 3 shows a system including two FTC modules 100 separated by an insulation interface plate 311. Each FTC module 100 has two end electrodes 102 and 110 for connecting to other FTC modules 100 or a power supply. FIG. 3 shows an electric lead 330 to represent all electric connections. As seen in FIG. 3, the two FTC modules 100 are assembled in a plastic housing 300 and secured between a top end cap 305 and a bottom end cap 307. The interchangeable water inlet 301 and water outlet 302 are disposed on the top end cap 305 and the bottom end cap 307 respectively. It should be noted that each FTC module 100 is not limited to 40 cells, the FTC module 100 may comprise any number of the cells comprising the bipolar electrodes 104. Furthermore, the FTC module 100 and the housing may have any dimensions to meet any capacity demands. The insulation interface plate 311 may comprise a plurality of perforated holes to allow water to flow from one FTC module 100 to the adjacent FTC module 100. Thus, the water gradually flow through the FTC modules 100. For controlling the operating voltage at a low level, for example 40V DC, all FTC modules 100 are charged in parallel. In the foregoing operation, the total operating current is the sum of the current needed at each FTC module 100. When the number and dimensions of the FTC modules 100 is large, the total current will be correspondingly large. A commercial power supply for providing large currents, for example, over 50 A, is very expensive as well. To reduce the cost, supercapacitor is employed to amplify the power output to meet any power needs for charging of FTC modules 100 in a cost effective manner. Compared to the modern power supply that uses digital electronics, the power provision using the supercapacitor is less sophisticated and have higher power capability. Therefore, the use of supercapacitor can be cost effective and reliable.

Depending on the size of FTC modules 100 and the volume of the waters to be treated, time periods needed to regenerate the saturated FTC electrodes may range from few minutes to few hours. An effective regeneration of the FTC electrodes is crucial to the throughput of the CDI treatments, as well as the commercial viability of the CDI technique. Since the FTC electrodes may be comprised of activated carbon, the regeneration of the electrode is actually a process to recondition the carbon surface from the adsorbed ionic contaminants. Even without the application of a DC potential, the activated carbon can intrinsically adsorb ions from waters. This nature adsorption property of activated carbon empowers the material as the most popular filtering medium employed in the treatments of many types of water. To regenerate the activated carbon is not an easy job. There are four general methods for carbon regeneration in the industry practices: solvent wash, acid or caustic wash, steam reactivation, and thermal regeneration. As the CDI technique is a chemical-free and energy effective approach of water treatment, only the solvent wash of the four aforementioned methods can be applied to the regeneration of the FTC electrodes.

A saturated FTC module 100 is equivalent to a fully charged supercapacitor. Both FTC module 100 and supercapacitor rely on ion adsorption to store electric energy at charging, and the accumulated charges of the ions on the electrode surface are the energy stored. Both FTC module 100 and the supercapacitor can quickly discharge their stored energy to a load such that the adsorbed ions get desorbed automatically and leave the electrode surface. Based on the foregoing discharge principle, the FTC electrodes are regenerated by “energy recovery”. To regenerate the FTC modules 100, first, the charged FTC modules 100 and the flow of water are turned off. Next, the rinsing water is continuously flowed through the FTC modules 100 and the terminals of the FTC modules 100 are connected to a load, for example, an uncharged supercapacitor, for discharging the stored energy of the FTC modules 100 and thereby unload the adsorbed ions. As the capacitors are known to leak their stored energies quicker than that of batteries, the saturated FTC modules 100 loses its energy at a even higher rate as soon as the charging potential is interrupted. Using a wattage meter, the residual energy of the FTC modules 100 that can be retrieved is about 30% of the energy previously input for the FTC array to adsorb ions. Furthermore, most of the residual energy of the FTC array is first transferred to the load at the very early moment of discharging, and then the FTC array and the supercapacitor until a state of equilibrium between the FTC modules 100 and the supercapacitor. So long as the residual voltage of the FTC modules 100 is not nullified, residual adsorbed ions always remain on the surface of the FTC electrodes, which may cause the cross contamination. Either the recovered energy is quickly transferred to the other energy reservoir, or another supercapacitor with low energy content may be used to exchange energy with the FTC modules 100 for further removal of adsorbed ions from the surface of the FTC electrodes.

During the “regeneration of the FTC electrodes 104 or energy exchange” process, the power supply is turned off and the polarity of the FTC electrodes is alternated at a preset time intervals, therefore, the FTC modules 100 and the supercapacitor, which are connected in parallel, can charge and discharge to each other. When the positive electrode of the FTC array is switched to negative polarity, the remaining energy of the FTC modules 100 becomes negative as well. Consequently, the supercapacitor will charge the FTC module 100. Due to alternating the polarity, rapid neutralization of the FTC modules 100 and the supercapacitor occur. The alternation of the polarity may cause negligible damage on the FTC modules 100 and the supercapacitor. The remaining residual adsorbed ions on the FTC electrodes can be rapidly drained by the rinsing water, thereby completing regeneration of the FTC electrodes. For reducing the operating voltage, the FTC modules 100 are charged in parallel so that one common voltage is applied on every cells of the FTC modules 100. For expediting the regeneration of the FTC electrodes, the FTC modules 100 are discharged in series using higher voltage for achieving rapid discharge rate. Therefore, the supercapacitor must be accommodated in high voltage module to accommodate the voltage contributed by all of the FTC electrodes during the regeneration process. Using an organic electrolyte system, the unitary working voltage of supercapacitor is generally around 2.5 V, which is far below the normal operating voltage, which is generally about 40 V Thus, the supercapacitors required to manage the power for both charging and discharging of the FTC modules 100 should be of high voltage and accommodated in high energy modules using the technique of “in-cell series connection” as disclosed in U.S. Pat. No. 6,762,926. Therefore, the supercapacitor modules can have a unitary working voltage of at least 30 V and a capacitance of at least 6 F.

Thus, the regeneration of FTC modules 100 can be rapidly achieved. Moreover, the energy of the saturated FTC modules 100 which is discharged during the regeneration of the FTC modules 100 is used for charging the supercapacitor which can be used as a power source.

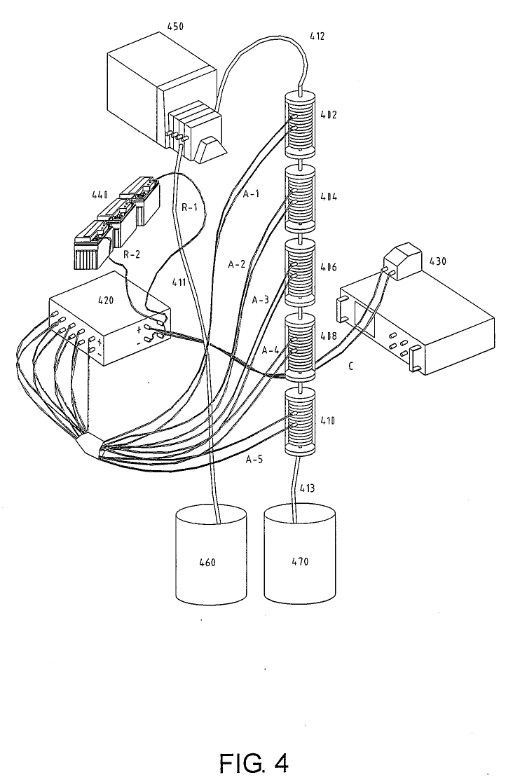

An automated CDI water treatment system including the bipolar FTC is shown in FIG. 4. A tandem arrangement of five bipolar modules, 402 to 410, are connected by a water conduit at the middle of each module to allow water to be drawn from a water reservoir 460 by pump 450 through tube 411 and tube 412 into FTC module 402 all the way down to FTC module 410. The water is desalted further and further as it cascades through the five FTC modules, finally, the treated water is collected in another water reservoir 470 through tube 413. An online sensor can be installed (not shown in FIG. 4) to determine if the collected water has met the TDS target, or it needs further deionization. As shown in FIG. 4, each FTC module has two electrical leads that are connected only to the end electrodes of the electrode stack sealed within each FTC module housing. Every pair of electrical leads is also connected to a power management kit 420 through individually designated cables, A-1 to A-5 for charging and discharging. A power supply 430 provides a potential, for example, 40 V, via the cable C to the power management kit 420 for charging the five bipolar FTC modules, 402 to 410, in parallel. By receiving the charging potential from the power supply 430 by the care of power management kit 420, each FTC module will remove ions from the water flowing through the FTC electrode stack. Therefore, the TDS of water will be decreasing as it flows down the FTC column. When the FTC electrodes become saturated from ion adsorption, the electrodes require regeneration to freshen their surface. Concurrently with the interruption of intake water entering the FTC array from tube 412, the charging potential provided to the FTC electrodes by the power supply 430 is terminated. Then, the residual energy of the FTC electrodes is reclaimed by charging an empty supercapacitor pack represented by 440 that is connected to the power management kit 420 through cables R-1 and R-2. During discharging, all five FTC modules are connected in series to expedite the dissipation of residual energy, which is a measure of ions left on the FTC electrode surface. However, the foregoing discharge will never reach completion, that is, the residual energy of FTC electrodes will never be dissipated completely and the residual voltage is never zero. For quick energy dissipation, another set of supercapacitor pack (not shown in FIG. 4) is connected to inputs on the other end of the power management kit 420 for performing “energy exchange” with the FTC modules. In the exchange, the FTC modules and the supercapacitor pack reciprocally charge each other resulting in electric shorts in the two devices due to the polarity reversal of the FTC modules. The supercapacitor packs employed for the energy recovery and the energy exchange contain plural units of supercapacitor that has six elements connected in series within a single housing as seen in 440. Each unitary supercapacitor has a rated working voltage of 15 V and a nominal capacitance of 40 F. Supercapacitor packs with high voltage and capacitance as demanded by the charging and discharging of the FTC modules can be formulated by a series, a parallel, or combinatory connections of the two. All CDI operations including deionization of waters and regenerations of FTC electrodes are conducted through PLC (programmable logic control).

### EXAMPLE 1

A FTC module 100 comprising 2 end electrodes 102 and 110 and 20 FTC electrodes 104 stacked between the two end electrodes as shown in FIG. 2 was used. Each FTC electrode 104 has a circular shape having a diameter of about 54 mm. Tap water was passed through the FTC module for removing the ions such as Mg²⁺ and Ca²⁺, from the water. Both of the end electrodes 102 and 110 were comprised of stainless steel disks coated with activated carbon and have the same diameter as that of the FTC electrodes 104. The end electrodes 102 and 110 were welded to a metal rod having 2 mm diameter, for compressing the FTC electrodes 104 between the two end electrodes 102 and 110 and for serving as the terminal for connecting to a power supply. The FTC electrodes 104 may be comprised of commercial carbon cloths made of activated carbon and fabrics having a bulk conductivity of 0.001 S/cm. The sealing members and the FTC electrodes 104 were stacked alternately such that a gap of about 1 mm was maintained between the FTC electrodes 104. The FTC module was disposed in a plastic housing with screw end caps having orifices serving as water inlet and outlet. The perforated holes for the metal rods, the terminals of the FTC module stick out of the housing. A lock-in mechanism was used to secure the metal rod at a suitable depth inside the housing that allows the FTC electrodes 100 to be compressed uniformly. Any deformation of the FTC electrodes 104 may adversely influence the electric field and permit the water to bypass.

150 ml of tap water with TDS at 160 ppm was delivered at a rate of 50 ml/min into the FTC module. As the water comes in contact with the first end electrode, a DC potential of 35 V is applied across the two terminals for the FTC electrodes 104 to create an electric field between the FTC electrodes 104 to effect removal of the ions, wherein the ions are adsorbed on the surface of the electrodes 104. During the deionization process, an operating current was measured to be 0.5 A, whereas the operating voltage remained unchanged. The TDS of the treated water was measured and was found to be 80 ppm. This test result has the following merits.

1. Maximum utilization of the efficiency of electrode was achieved and no leakage of water was observed to cross contaminate the treated water.

2. The FTC electrodes 104 were connected in series so that the applied voltage is shared evenly by the 20 unit cells. The significant reduction of TDS indicates that the hydrolysis of water did not occur during the treatment process, and the treated water temperature remained at ambient temperature suggesting that there was no occurrence of ohmic heating.

3. The FTC electrode scheme with no connection to a power supply is applicable to the CDI technique for reducing the TDS of water via surface adsorption.

### EXAMPLE 2

A system comprising five FTC modules 100 was used for treating water, wherein each FTC module 100 comprises the configuration of the FTC module 100 used in EXAMPLE 1. The FTC modules 100 are connected in series and are used for desalination of seawater. Though the five modules are connected in series for water flow, they are charged in parallel by applying a voltage, of about 35 V DC. 1 liter of filtered seawater with TDS of about 35,000 ppm was delivered at a rate of 50 ml/min through the FTC modules 100 in one pass. During the charging period, the working current is registered as 3 A, and the TDS of the treated water was measured and was found to be reduced to 2500 ppm in one-pass treatment.

A group of supercapacitor modules comprising three supercapacitors were used for regenerating the FTC modules 100. Each supercapacitor has a specification of 30 V×20 F, and are connected in series to form a pack of 90 V×6.7 F and serve as an energy-reservoir for the regeneration of the five FTC modules 100. Since the dimensions of the FTC modules 100 are small and only a small amount of ions are adsorbed, the group of the supercapacitors can match the sum total voltages of the residual potentials of the five FTC modules 100. TABLE 1 shows the results of the regeneration of the five FTC modules 100 with and without the “energy exchange”.

TABLE 1
Comparison of the Regeneration of FTC Modules
With and Without Energy Exchange

| | Targets | | |
|---|---|---|---|
| Processes | (ppm)^{§} | Water Used | Time Elapsed |
| Water* wash + Exchange | 100 | 2 liters | 8 minutes |
| Water* wash only | 100 | 12 liters | 2 hours |

*Deionied water (TDS = 4 ppm) is used as the rinse water.
^{§}Background reading of TDS of the rinse water.

As seen in TABLE 1, the “energy exchange” technique has provided a synergistic effect to the regeneration of FTC modules 100, wherein the modules are regenerated much faster consuming much less precious resource, the freshwater, than the regeneration using solvent wash only. The regeneration of the FTC modules 100 require no chemical or electricity. Incidentally, patent '042 employs a flow through “battery” containing 150 cells with an adsorption area of 200 cm² for each cell, or a total adsorptive area of 3 m² for the whole stack, to desalt 14 liters of NaCl solution from 800 ppm to 300 ppm, which takes 2-4 hours of deionization time. In other words, 7000 mg of salt, that is, 14×500, is removed by 30,000 cm² effective electrode area in 4 hours (240 minutes) by patent '042. Thus, the salt retention rate of patent '042 is 0.00097 mg/cm²·min. In comparison, the present invention has removed 2500 mg of salt using 2000 cm² electrode area in 20 minutes, so, the salt retention rate is 0.062 mg/cm²·min.

Accordingly, the present invention has at least the following advantages.

The CDI technique provides an energy effective an chemical free process for treating water with a high throughput. By utilizing the maximum efficiency and the regeneration of the FTC electrodes 104, the CDI technique can be viable for treating large volume of water for industrial use.

Maximum utilization of the efficiency of the FTC electrodes 104 can be achieved and the FTC electrodes 104 can be easily assembled of FTC modules 100 coupling with the reduction of the production cost. While the “energy exchange” of two capacitors, that is, the FTC module 100 and supercapacitor, is an innovative technique of activated carbon regeneration, the saturated FTC electrodes 104 are thereby rapidly regenerated with a minimal use of rinse water. When an ion-adsorptive material with high specific area (high m²/g), high conductivity (high S/cm), and high meso phase (pore diameter is between 2 nm and 50 nm) content is identified for making the FTC electrodes, the salt retention rate of the electrodes may be increased.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A capacitive deionization (CDI) system, for deionizing water, comprising:
at least a flow through capacitor (FTC) module, comprising a plurality electrodes, for removing ions from water flowing between the electrodes under an electric field applied between the electrodes;
a potential source, for supply electric energy to the FTC module;
at least a first supercapacitor, connected between the potential source and the FTC module, for amplifying energy provided by the potential source;
at least a second supercapacitor, connected to the FTC module, for receiving energy from the FTC module for regenerating the electrodes of the FTC module;
at least a third supercapacitor, for exchanging energy with the FTC module for regenerating the electrodes of the FTC module; and
a controller, for regulating deionization rate of the water, energy recovery and regeneration of the electrodes of the FTC module.

2. The CDI system as claimed in claim 1, wherein the potential source comprises a primary battery, a secondary battery, a fuel cell or a solar cell.

3. The CDI system as claimed in claim 1, wherein the electrodes are comprised of carbon cloth, and metal substrates covered with carbonaceous material or metal oxides.

4. The CDI system as claimed in claim 3, wherein the metal substrates comprise stainless steel, titanium or nickel.

5. The CDI system as claimed in claim 3, wherein the carbonaceous material comprises activated carbon, carbon nanotube or C₆₀.

6. The CDI system as claimed in claim 3, wherein the metal oxide comprises manganese dioxide, iron oxide, doped titanium oxide or nickel oxide.

7. The CDI system as claimed in claim 1, wherein the electrodes are embedded in sealing members comprising a plurality of radially arranged stripes surrounded by an edge seal.

8. The CDI system as claimed in claim 7, wherein the sealing members comprise ethylene propylene diene monomer, epoxy modified silicone, ethylene vinyl acetate, nylon or teflon.

9. The CDI system as claimed in claim 1, wherein the first, second and third supercapacitors have at least a working voltage of 30 V, and at least a capacitance of 6 F.

10. The CDI system as claimed in claim 9, wherein the first, second and third supercapacitors comprise serially connected cells, parallel connected cells, or serially and parallel connected cells.

11. The CDI system as claimed in claim 1, wherein the FTC module and the third supercapacitor are connected in parallel.

12. The CDI system as claimed in claim 11, wherein terminals of the FTC module is alternated at every 30 seconds or longer.

13. The CDI system as claimed in claim 1, wherein the electrodes comprise a configuration of a mesh, a screen or a wire network.

14. The CDI system as claimed in claim 1, wherein a gap of 1 mm is formed between the electrodes.
